(19) United States
(12) Patent Application Publication
(10) Pub. No.: US 2024/0152591 A1
(43) Pub. Date: May 9, 2024

(54) ACCESS CONTROL FOR APPLICATIONS

(71) Applicant: ISORG, Limoges CEDEX 3 (FR)

(72) Inventors: Jean-Yves GOMEZ, Grenoble (FR); Jérôme JOIMEL, Grenoble (FR); Jérôme MICHALLON, Grenoble (FR); Benjamin BOUTHINON, Grenoble (FR); Camille DUPOIRON, GRENOBLE (FR)

(21) Appl. No.: 18/282,736

(22) PCT Filed: Mar. 15, 2022
(86) PCT No.: PCT/EP2022/056693

§ 371 Date: Sep. 18, 2023

(30) Foreign Application Priority Data
Mar. 19, 2021 (FR) FR2102767
Mar. 19, 2021 (FR) FR2102768

(51) Int. Cl. G06F 21/32; G06F 21/34; G06F 21/62

(52) U.S. Cl. CPC G06F 21/32; G06F 21/34; G06F 21/629

(57) ABSTRACT

An electronic device adapted to executing at least one application, includes an access control, wherein a number of authentication means implemented by the access control is settable according to a security level assigned to the application.

### RELATED APPLICATIONS

The present application claims the priority benefit of French patent applications 21/02767 and 21/02768 which will be considered an integral part of the present disclosure to the extent permitted by law.

### FIELD

The present disclosure generally concerns electronic devices. The present disclosure more particularly concerns means and methods for controlling the access, by a user of an electronic device, to one or a plurality of applications executed by this device.

### BACKGROUND

Electronic devices such as smart cell phones or smartphones, touch pads, connected watches, etc. capable of executing one or a plurality of applications are known. Some of these applications may comprise an access control particularly guaranteeing that confidential or secret data, for example bank data of a user of the device, can only be made accessible to third parties with the user's authorization.

### SUMMARY OF THE INVENTION

To guarantee an optimal protection of the confidential data of the users of electronic devices, there exists a permanent need to reinforce means and methods for controlling the access to the applications executed by these devices.

An embodiment overcomes all or part of the disadvantages of known means and methods for controlling the access to one or a plurality of applications executed by an electronic device.

An embodiment provides an electronic device adapted to executing at least one application comprising an access control, wherein a number of authentication means implemented by the access control is settable according to a security level assigned to the application.

According to an embodiment, the authentication means comprise at least one biometric sensor.

According to an embodiment, the biometric sensor is a fingerprint sensor.

According to an embodiment, the fingerprint sensor is adapted to simultaneously acquiring fingerprints of a plurality of fingers, preferably from two to four fingers.

According to an embodiment, the fingers form part of a same hand.

According to an embodiment, a number of fingerprints simultaneously acquired by the fingerprint sensor is adjusted according to the security level assigned to the application.

According to an embodiment, the authentication means comprise an access code.

According to an embodiment, the authentication means comprise a geolocation system.

According to an embodiment, the authentication means comprise a peripheral interacting with the device.

According to an embodiment, the setting of the number of authentication means implemented by the access control is performed by a user of the electronic device.

According to an embodiment, the setting of the number of authentication means implemented by the access control is performed by a developer of the application.

An embodiment provides a method comprising the step of setting, according to a security level assigned to said at least one application adapted to being executed by an electronic device, a number of authentication means implemented by a control of the access to said application.

An embodiment provides an electronic device comprising a fingerprint sensor adapted to simultaneously acquiring fingerprints of a plurality of fingers, preferably from two to four fingers.

According to an embodiment, the fingers are selected from among fingers of two hands of a same user.

According to an embodiment, a number of fingerprints simultaneously acquired by the sensor is adjusted according to a security level assigned to an application executable by the device.

According to an embodiment, the application has access to bank data of a user of the device.

According to an embodiment, the number of fingerprints simultaneously acquired by the sensor is further adjusted according to an amount of a money transfer performed by the device.

According to an embodiment, the number of fingerprints simultaneously acquired by the sensor is settable.

According to an embodiment, the setting is performed by a user of the electronic device.

According to an embodiment, the setting is performed by a developer of the application.

An embodiment provides a method comprising the step of simultaneously acquiring, by a fingerprint sensor of an electronic device, fingerprints of a plurality of fingers, preferably from two to four fingers.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 is a simplified and partial top view of an example of electronic device of the type to which apply, as an example, described embodiments and implementation modes;

FIG. 2 schematically illustrates a step of an implementation mode of a method of parameterizing a control of the access to an application;

FIG. 3 schematically illustrates a variant of the step of FIG. 2;

FIG. 4 schematically illustrates another step of the implementation mode of the method of parameterizing the control of the access to an application;

FIG. 5 schematically shows in the form of blocks authentication means in relation with the implementation mode of the method of FIGS. 2 to 4;

FIG. 6 schematically an implementation mode of an authentication step;

FIG. 7 schematically illustrates another implementation mode of an authentication step;

FIG. 8 schematically illustrates still another implementation mode of an authentication step; and

FIG. 9 schematically illustrates still another implementation mode of an authentication step.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for the understanding of the described embodiments have been illustrated and described in detail. In particular, the software implementation of the described access control methods is not described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front”, “back”, “top”, “bottom”, “left”, “right”, etc., or relative positions, such as terms “above”, “under”, “upper”, “lower”, etc., or to terms qualifying directions, such as terms “horizontal”, “vertical”, etc., it is referred, unless specified otherwise, to the orientation of the drawings.

Unless specified otherwise, the expressions “about”, “approximately”, “substantially”, and “in the order of” signify plus or minus 10%, preferably of plus or minus 5%.

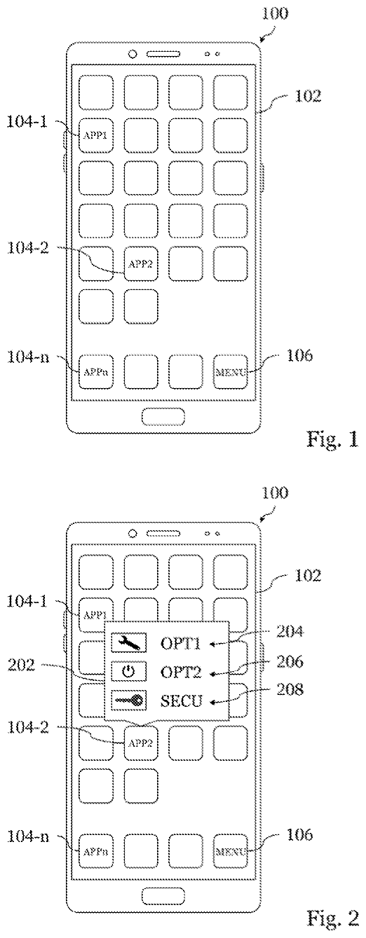

FIG. 1 is a simplified and partial top view of an example of an electronic device 100 of the type to which apply, as an example, described embodiments and implementation modes.

In the shown example, electronic device 100 is a cell phone, for example a smart cell phone or smartphone, comprising on its front side a display screen 102, preferably a touch screen. This example is however not limiting, the embodiments and implementation modes of the present disclosure more generally applying to any electronic device comprising a touch screen, for example touch pads, connected watches, activity trackers, etc. The screen 102 of phone 100 for example enables to display, once phone 100 has been unlocked by a user, a home screen comprising icons for launching applications executable by phone 100. In the example illustrated in FIG. 1, screen 102 more precisely displays a number n of icons 104-1, 104-2, . . . 104-n. Number n is an integer for example in the range from 3 to 30.

In this example, icons 104-1, 104-2, . . . 104-n are distributed in a grid. Each icon 104-1, 104-2, . . . 104-n for example enables to start or to resume the execution of an application APP1, APP2, . . . APPn. In a case where the screen 102 of phone 100 is tactile, the execution of each application APP1, APP2, . . . APPn is for example launched or resumed by a short pressing, of a duration typically shorter than one second, by a user's finger on screen 102 on the corresponding icon 104-1, 104-2, . . . 104-n.

Applications APP1, APP2, . . . APPn may be installed on phone 100, for example stored in a non-volatile memory (not shown) of phone 100. As a variant, all or part of applications APP1, APP2, . . . APPn are installed outside of phone 100, for example stored on a server or cloud.

In the shown example, screen 102 further displays an icon 106 (MENU) enabling to access a setting menu of phone 100. The setting menu particularly enables the user to modify options relative to the applications APP1, APP2, . . . APPn executable by phone 100. As an example, the setting menu further enables to the user to configure and to activate wireless communication functionalities of phone 100 with mobile telephony networks or with other electronic devices, to personalize an aspect of a graphic interface of system software executed by phone 100, to adjust luminosity and sound options, to parameterize email accounts, to modify power management profiles, etc.

Among the applications APP1, APP2, . . . APPn executable by phone 100, certain applications comprise an access control. The access control particularly aims at ascertaining that a person desiring to use an application owns rights or privileges required by this application. This enables in particular to guarantee that personal, confidential, or secret data used by the application can only be accessible to third parties with the agreement of the user of phone 100.

The access control is for example implemented prior to each launching or starting of the application. The access control may further be implemented subsequently by the application one or a plurality of times during its execution, for example when operations using personal, confidential, or secret data of the user of phone 100 are being carried out.

As an example, bank applications such as payment applications and/or online banking, secure messaging applications, medical or health applications, electronic safe applications, etc. generally comprise an access control. In the case of an online banking application, the access control is for example performed at the launching of the application, for example when the user starts the application to consult an account balance, as well as for each operation of addition of a beneficiary or of money transfer, for example for each contactless payment via phone 100.

FIG. 2 schematically illustrates a step of an implementation mode of a method of parameterizing a control of the access to an application, application APP2 in the shown example.

In this example, screen 102 displays a menu 202 for parameterizing application APP2, menu 202 being symbolized in FIG. 2 by a dialog box pointing towards the icon 104-2 of application APP2. In the shown example, menu 202 comprises icons 204 (OPT1) and 206 (OPT2) for example enabling to set various options of application APP2, to uninstall application APP2 from the memory of phone 100, to displace icon 104-2 on the grid of the home screen, etc.

According to an implementation mode, the setting menu 202 of application APP2 further comprises an icon 208 (SECU) via which the user can access a menu for setting access control parameters of application APP2. An example of such a menu is described hereafter in relation with FIG. 4.

As an example, in the case where screen 102 is tactile, the display of the setting menu 202 of each application APP1, APP2, . . . APPn results from a long pressing, of a duration typically longer than one second, of the user's finger on screen 102 above the corresponding icon 104-1, 104-2, . . . 104-n.

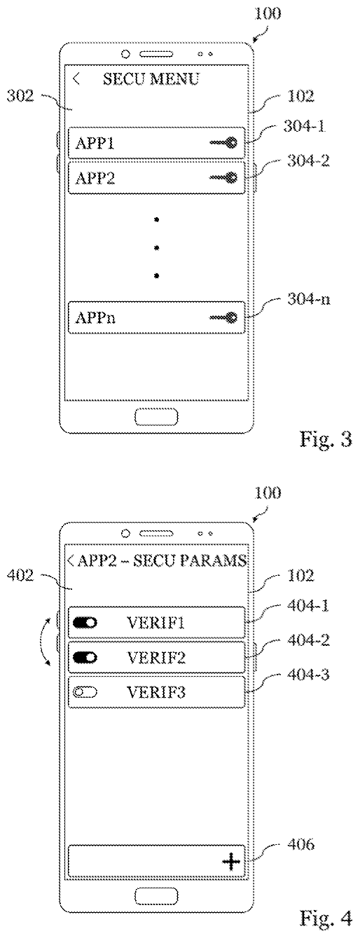

FIG. 3 schematically illustrates a variant of the step of FIG. 2.

In this variant, the screen 102 of phone 100 displays a menu 302 (SECU MENU) from which the user can access the access control parameters of each of applications APP1, APP2, . . . APPn. Menu 302 is for example a sub-menu of the setting menu of device 100 accessible by a short pressing on screen 102 above icon 106.

In the shown example, menu 302 comprises icons 304-1, 304-2, . . . 304-n enabling the user to access menus for setting the access control of the applications, respectively APP1, APP2, . . . APPn, executable by phone 100. Each menu accessible from one of icons 304-1, 304-2, . . . 304-n is for example identical to the menu accessible from the icon 208 of the menu 202 associated with each icon 104-1, 104-2, . . . 104-n of the home screen as previously discussed in relation with FIG. 2.

The menu for setting the access control of each application APP1, APP2, . . . APPn executable by device 100 is, preferably, indifferently accessible by the implementation of the step of FIG. 2 or by the implementation of the step of FIG. 3. This gives the user more flexibility to access the access control parameters. As a variant, the menu for setting the access control of each application APP1, APP2, . . . APPn is only accessible by the implementation of one or the other of the steps respectively described in relation with FIGS. 2 and 3.

FIG. 4 schematically illustrates another step of the implementation mode of the method of parameterizing the control of the access to application APP2.

FIG. 4 more precisely illustrates an example of a menu 402 (APP2-SECU PARAMS) for setting the access control of application APP2 displayed by the screen 102 of phone 100. Menu 402 is for example accessible, at the user's choice, from icon 208 of the menu 202 of application APP2 (FIG. 2) or from icon 304-2 of menu 302 (FIG. 3).

In the shown example, menu 402 comprises a list of elements 404-1 (VERIF1), 404-2 (VERIF2), and 404-3 (VERIF3). Each element 404-1, 404-2, 404-3 symbolizes at least one authentication means associated with the control of the access to application APP2. In this example, each element 404-1, 404-2, 404-3 of menu 402 comprises a switch enabling to active or to deactivate the authentication means associated with this element. In the example illustrated in FIG. 4, authentication means VERIF1 and VERIF2 are activated while authentication means VERIF3 is deactivated.

In this example, the control of the access to application APP2 implements means VERIF1 and VERIF2, but not means VERIF3. Thus, each time application APP2 exerts the access control, authentication means VERIF1 and VERIF2 are implemented. The order in which the activated authentication means (VERIF1 and VERIF2, in this example) are implemented by the access control is for example settable by the user by vertically displacing, in the orientation of FIG. 4, elements 404-1 and 404-2 with respect to each other, as symbolized by a double arrow in FIG. 4. As an example, in the orientation of FIG. 4, the authentication means corresponding to the elements located at the top of the list are implemented before the authentication means corresponding to the elements located at the bottom of the list.

The activation and the deactivation of each authentication means implemented by the control of the access to application APP2 are for example each conditioned by the obtaining of a prior authorization. As an example, any state change of the switch of one of elements 404-1, 404-2, 404-3 may be submitted to a prior authentication method, for example by a keying in of a personal code or a biometric identification of the user of phone 100. This enables to avoid for one or a plurality of authentication means to be activated or deactivated without the user's knowledge. As a variant, the deactivation or the activation of authentication means is submitted to a prior authorization.

According to an implementation mode, the control of the access to application APP2 implements a settable number of authentication means. This number is for example selected by a user of phone 100. As a variant, this number may be determined by a developer of application APP2, where the user then for example does not have the possibility, in this case, of decreasing it or of modifying it.

The setting of the number of authentication means implemented by the control of the access to application APP2 is performed, preferably, according to a security level assigned to application APP2.

Generally, the security level assigned to each application is for example defined according to an estimate of a prejudice that would be caused to the user by an unwanted or incidental communication, to one or a plurality of third parties, of the personal data accessible by the application, possibly followed by a processing of these data by the third party or parties. As an example, there is considered as having a high security level any application having a right of access to confidential or secret data of the user such as bank data, an address, medical data, encrypted messages, private photographs and/or videos, etc.

In the shown example, menu 402 comprises another element 406 (+) enabling the user to add one or a plurality of additional authentication means for the implementation of the control of the access to application APP2. In the same way as for the activation and/or the deactivation of an authentication means already present in the list of menu 402, the addition of a new authentication means to this list may be submitted to a prior authorization. The addition of a new authentication means may further be accompanied by a parameterizing step if this authentication means is not or does not already have been used by application APP2 or by one of the other applications of phone 100.

Although this has not been illustrated in FIG. 4, it may be provided for at least one of elements 404-1, 404-2, and 404-3 to be able to be removed from the list by the user and/or by a developer of application APP2.

Although there has been described hereabove in relation with FIGS. 2 to 4 an implementation mode of a method of parameterizing the control of the access to application APP2, this implementation mode is transposable to the parameterizing of the access control of all or part of the other applications executable by phone 100.

The user may preferably individually personalize the number of authentication means implemented by the control of the access to each application executable by phone 100. An advantage of this personalization of the number of authentication means lies in the fact that this enables the user to increase this number to reinforce the access control. The user may for example also individually personalize the nature of the authentication means implemented by the control of the access to each application. This for example enables to replace authentication means with other more robust authentication means, to reinforce the access control. The user data accessible by the applications APP1, APP2, . . . APPn of phone 100 thus benefit from an increased protection.

FIG. 5 schematically shows in the form of blocks authentication means in relation with the implementation mode of the method of FIGS. 2 to 4.

In FIG. 5, a block 500 (CTRL) symbolizes the control of the access to an application, for example application APP2 of phone 100.

According to an embodiment, access control 500 implements at least one biometric-type authentication means 502 (BIO). The biometric authentication means is selected, preferably, among:
a face recognition sensor or system 504 (FACE);
another iris recognition sensor or system 506 (IRIS);
still another sensor or system 508 (PALM) for recognizing the palm of a hand;
still another fingerprint recognition sensor or system 510 (FP);
still another sensor or system 512 (VEINS) for recognizing a venous network of a hand or of a portion of a hand; and
still another voice recognition sensor or system 514 (VOICE).

Face recognition, iris recognition, and palm recognition sensors or systems 504, 506, and 508 for example comprise at least one image sensor located on the front side of phone 100.

Sensors or systems 510 and 512 for recognizing fingerprints and for recognizing a venous network for example comprise at least one image sensor. This image sensor is for example located on the front side of phone 100. According to an embodiment, the image sensor is integrated inside of or under the screen 102 of phone 100. As a variant, the image sensor is located on the back side of phone 100 or on the side of phone 100. Voice recognition sensor or system 514 for example comprises at least one microphone of phone 100.

According to an embodiment, fingerprint recognition sensor or system 510 may acquire the fingerprint of a single finger 510-1 (1F), or successively or simultaneously acquire the fingerprints of two fingers 510-2 (2F), of three fingers 510-3 (3F), or of four fingers 510-4 (4F) of a same hand. As a variant, although this has not been shown in FIG. 5, it could be provided for sensor or system 510 to be able to successively or simultaneously acquire the fingerprints of five fingers of a same hand.

The control of the access to application APP2 may further implement at least one digital-type authentication means 516 (NUM). The digital authentication means is selected for example from among:
a two-dimensional code 518 (2D CODE), for example a two-dimensional bar code of the type designated by expressions “flashcode”, “datamatrix”, or “QR code”;
an unlocking scheme 520 (LOCK SCH) for example comprising a set of points displayed by the screen 102 of phone 100, all or part of these points being intended to be touched or connected according to an order generally predefined by the user; and
a confidential or personal code 522 (PIN CODE), for example a digital or alphanumerical code comprising at least four characters.

Code 518 is for example photographed by an image sensor located at the back of phone 100 and then processed by an algorithm executed by a microprocessor of phone 100. As a variant, code 518 may be photographed by an image sensor located on the front side of phone 100, for example by the fingerprint sensor located inside of or under the screen 102 of phone 100.

Although this has not been shown in FIG. 5, another digital-type authentication means 516 comprising a reading, by phone 100, of a near-field communication (NFC) tag, or NFC tag may be provided.

The control of the access to application APP2 may further implement at least one authentication means of another type 524 (MISC). This authentication means is for example selected from among:
a peripheral 526 (EXT) external to phone 100, for example another electronic device communicating with phone 100; and
a geolocation system 528 (GEO), for example based on a GPS communication module of phone 100.

Geolocation system 528 for example enables to forbid the access to certain applications, or to certain functionalities of the applications, when phone 100 is outside of at least one geographical perimeter. This perimeter is for example defined by the user. This for example advantageously enables to block the access to the user's personal data in case of theft of phone 100.

Elements 404-1, 404-2, and 404-3 of the list of the menu 402 of FIG. 4 for example each correspond to one or a plurality of authentication means among means 504, 506, 508, 510, 512, 514, 518, 520, 522, 526, and 528 of FIG. 5.

In the case where access control 500 is exerted by an application having a high security level, for example an application having access to bank data, a minimum number of authentication means, certain authentication means, and/or certain types of authentication means may be imposed for example by a designer of the application.

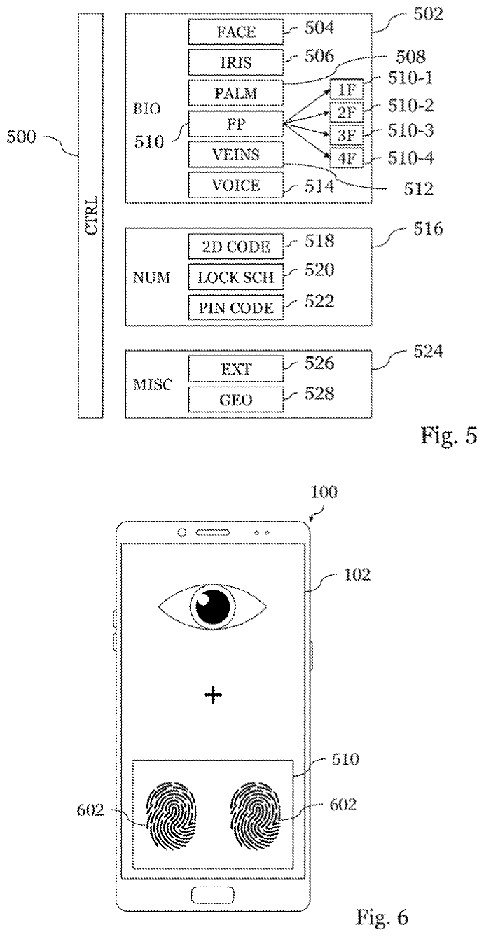

FIG. 6 schematically illustrates an implementation mode of an authentication step. FIG. 6 more precisely illustrates an example where two authentication means are simultaneously implemented by the control of the access to an application of phone 100.

In the shown example, the screen 102 of phone 100 indicates to the user that an iris recognition, symbolized in FIG. 6 by an eye displayed on screen 102, and a fingerprint recognition, symbolized in FIG. 6 by two fingerprints 602 displayed on screen 102, are simultaneously required. Fingerprint sensor 510 is preferably located inside of or under the screen 102 of phone 100. In the shown example, sensor 510 occupies a lower portion, in the orientation of FIG. 6, of phone 100.

To carry out the authentication step illustrated in FIG. 6, the user may for example hold phone 100 in their left hand, screen 102 facing them, while laying two fingers, for example the index and middle finger of their right hand, on sensor 510.

The fact of simultaneously performing an iris recognition and a fingerprint recognition advantageously enables to improve the security of the access control.

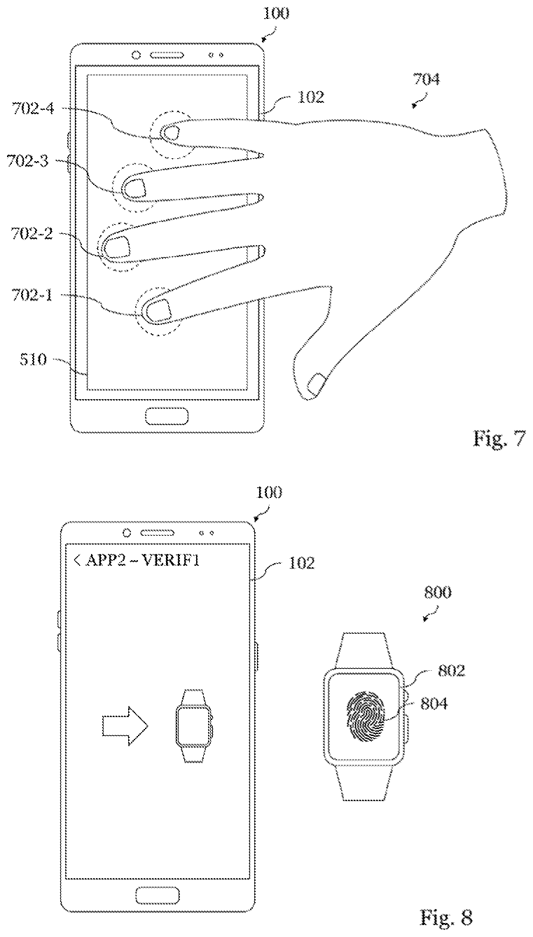

FIG. 7 schematically illustrates another implementation mode of an authentication step.

According to this implementation mode, during the authentication step, the user is asked to place four fingers 702-1, 702-2, 702-3, and 702-4 of a same hand 704, for example the index, the middle finger, the ring finger, and the little finger of their right hand, on the screen 102 of phone 100. The fingerprints of the four fingers 702-1, 702-2, 702-3, and 702-4 of the user's hand 704 are preferably acquired simultaneously, preferably to within a few milliseconds or tens of milliseconds, by sensor 510.

According to an embodiment, sensor 510 is located inside or under screen 102. Further, sensor 510 preferably occupies a surface area substantially equal to a surface area of the screen 102 of phone 100. As a variant, sensor 510 occupies a surface area smaller by approximately at most 30% than the surface area of the screen 102 of phone 100. Generally, sensor 510 is in this case adapted to simultaneously acquiring fingerprints of a plurality of fingers, preferably from two to four fingers, selected from the fingers of a same hand of the user. As a variant, the fingers having their fingerprints simultaneously acquired by sensor 510 are selected from among the fingers of the user's two hands. According to this variant, the fingerprints of the user's two thumbs are preferably acquired.

According to an implementation mode, a number of fingerprints simultaneously acquired by sensor 510 is adjusted according to the security level of the application. As an example, sensor 510 is set to simultaneously acquire two fingerprints for a first application having a low security level while sensor 510 is set to simultaneously acquire four fingerprints for a second application having a high security level, for example higher than the security level of the first application.

Further, when the application is for example adapted to performing money transfers, for example contactless payments or bank transfers from one account to another, the number of fingerprints simultaneously acquired by sensor 510 preferably increases according to a desired amount of the money transfer.

As an example:
for an amount smaller than a first sum of money, for example 50 €, a single fingerprint is required to validate the transfer;
for an amount between the first sum of money and a second sum of money greater than the first sum of money, for example 100 €, two fingerprints are simultaneously required to validate the transfer;
for an amount between the second sum of money and a third sum of money greater than the second sum of money, for example 250 €, three fingerprints are simultaneously required to validate the transfer; and
for an amount greater than the third sum of money, four fingerprints are simultaneously required to validate the transfer.

To indicate to the user the number of fingerprints to be acquired, a plurality of finger positioning areas are for example displayed on screen 102. These areas are, in FIG. 7, symbolized by circles in dotted lines, it being understood that, in practice, screen 102 may display a symbol or an image different from a circle in dotted lines. Preferably, screen 102 displays a number of areas identical to the number of fingerprints to be simultaneously acquired by sensor 510 to ask the user to place on screen 102 the adequate number of fingers. However, due to the fact that the sensor covers a large portion of the screen 102 of phone 100, the user is not constrained to place his or her fingers above the circles in dotted lines for its fingerprints to be correctly acquired. As a variant, screen 102 may display an image symbolizing a hand and exhibiting a number of raised fingers corresponding to the number of fingerprints to be simultaneously acquired by sensor 510.

The fact of providing the simultaneous acquisition of the fingerprints of the four fingers 702-1, 702-2, 702-3, and 702-4 of the same hand 704 of the user advantageously enables to benefit from more robust authentication means than in the case of the acquisition of the fingerprint of a single finger of hand 704 and than in the case of a successive acquisition of a plurality of fingers of a hand. This enables to reinforce access controls implementing this authentication means. The user data accessible by the applications APP1, APP2, . . . APPn of phones 100 thus benefit from a reinforced protection.

FIG. 8 schematically illustrates still another implementation mode of an authentication step.

According to this implementation mode, during the authentication step, the user is asked to use a peripheral 800, for example a connected watch as illustrated in FIG. 8, to perform the access control. A fingerprint sensor (not shown) is for example integrated to a display screen 802 of watch 800. The screen 102 of phone 100 for example displays a graph (APP2-VERIF1) comprising a diagram asking the user to consult watch 800. Further, the screen 802 of watch 800 for example displays a symbol 804 showing a fingerprint to incite the user to place a finger on the screen 802 of watch 800.

As an example, the fingerprint captured by watch 800 is compared with one or a plurality of reference fingerprints, or minutiae, previously recorded by the user. The reference fingerprints are for example stored in a memory of watch 800, the comparison then being performed independently from phone 100. As a variant, the reference fingerprint(s) are stored in the memory of phone 100, the fingerprint captured by watch 800 then being for example transmitted by a secure wireless communication to phone 100, to be compared with this or these reference fingerprint(s). If the fingerprint acquired by watch 800 corresponds to one of the reference fingerprints stored in watch 800 or in phone 100, the access to the application is for example authorized.

Although this has not been shown, connected watch 800 may implement one or a plurality of authentication means among those listed in relation with FIG. 5.

An advantage of this implementation mode lies in the fact that the access control requires gathering a plurality of devices, in the case in point phone 100 and watch 800. In case of a loss or theft of phone 100 alone or of watch 800 alone, the user data accessible by the applications of phone 100 are thus better protected.

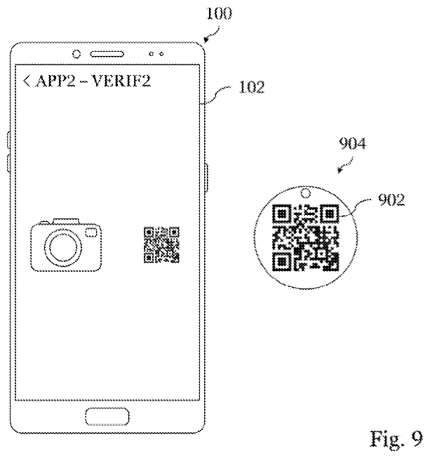

FIG. 9 schematically illustrates still another implementation mode of an authentication step.

According to this implementation mode, during the authentication step, the user is asked to photograph a two-dimensional bar code 902 to validate the access control. In this example, bar code 902 is printed or etched on a token 904. The screen 102 of phone 100 for example displays a graph (APP2-VERIF2) comprising a diagram inciting the user to photograph the bar code 902 of token 904.

An advantage of this implementation mode lies in the fact that the access control requires gathering a plurality of objects, in the case in point phone 100 and token 904. In case of a loss or theft of phone 100 alone or of token 904 alone, the user data accessible by the applications of phone 100 are thus better protected.

Various embodiments and variants have been described. Those skilled in the art will understand that certain features of these various embodiments and variants may be combined, and other variants will occur to those skilled in the art. In particular, the described embodiments and implementation modes are not limited to the authentication means listed in the present disclosure.

Further, those skilled in the art are capable of providing, for the control of the access to an application, any combination of authentication means, implemented successively or simultaneously, according for example to the security level of the application. The possible combinations are not limited to those discussed in detail in the present disclosure.

Finally, the practical implementation of the described embodiments and variants is within the abilities of those skilled in the art based on the functional indications given hereabove. In particular, the implementation of the different sensors and/or elements taking part in the control of the access to each application is within the abilities of those skilled in the art based on the indications of the present disclosure.

1. An electronic device adapted to executing at least one application, the electronic device comprising: an access control, wherein a number of authentication means implemented by the access control is settable according to a security level assigned to the application.

2. The electronic device according to claim 1, wherein the authentication means comprise at least one biometric sensor.

3. The electronic device according to claim 2, wherein the biometric sensor is a fingerprint sensor.

4. The electronic device according to claim 3, wherein the fingerprint sensor is adapted to simultaneously acquiring fingerprints of a plurality of fingers.

5. The electronic device according to claim 4, wherein the fingers form part of a same hand.

6. The electronic device according to claim 4, wherein a number of fingerprints simultaneously acquired by the fingerprint sensor is adjusted according to the security level assigned to the application.

7. The electronic device according to claim 1, wherein the authentication means comprise an access code.

8. The electronic device according to claim 1, wherein the authentication means comprise a geolocation system.

9. The electronic device according to claim 1, wherein the authentication means comprise a peripheral interacting with the device.

10. The electronic device according to claim 1, wherein the setting of the number of authentication means implemented by the access control is performed by a user of the electronic device.

11. The electronic device according to claim 1, wherein the setting of the number of authentication means implemented by the access control is performed by a developer of the application.

12. A method comprising the step of: setting, according to a security level assigned to at least one application adapted to being executed by an electronic device, a number of authentication means implemented by a control of the access to said application.

13. The method according to claim 12, wherein the authentication means comprise a fingerprint sensor adapted to simultaneously acquiring fingerprints of a plurality of fingers.

14. The method according to claim 13, wherein the fingers form part of a same hand.

15. The method according to claim 13, wherein a number of fingerprints simultaneously acquired by the fingerprint sensor is adjusted according to the security level assigned to the application.

16. The method according to claim 13, wherein the plurality of fingers comprise from two to four fingers.

17. The electronic device according to claim 4, wherein the plurality of fingers comprise from two to four fingers.
